(19) United States
(12) Patent Application Publication
(10) Pub. No.: US 2014/0259167 A1
(43) Pub. Date: Sep. 11, 2014

(54) BEHAVIOR BASED APPLICATION BLACKLISTING

(71) Applicant: SAMSUNG ELECTRONICS CO. LTD., Suwon-si (KR)

(72) Inventors: Karishma BABU, Plano, TX (US); Hashir KHAN, Dallas, TX (US)

(73) Assignee: SAMSUNG ELECTRONICS CO. LTD., Suwon-si (KR)

(21) Appl. No.: 13/793,069

(22) Filed: Mar. 11, 2013

(51) Int. Cl. G06F 21/55

(52) U.S. Cl. CPC G06F 21/55
USPC 726/23

(57) ABSTRACT

A network system and a method for detecting behavior in a network device are provided. The method includes generating a list of one or more prohibited behaviors, generating a list of one or more corrective actions, mapping each of the one or more prohibited behaviors to at least one of the one or more corrective actions, identifying one or more of a user, a process or an application involved in a prohibited behavior, and applying, to the one or more of the user, the process or the application involved in the prohibited behavior, the at least one of the one or more corrective actions mapped to the prohibited behavior performed.

### BACKGROUND OF THE INVENTION

1. Field of the Invention

The present invention relates to a system and method for detecting prohibited behaviors in a computer network or device thereof. More particularly, the present invention relates to a system and method for generating a list of prohibited behaviors and a list of corrective actions mapped to the prohibited behaviors that, in connection with monitoring conditions, aid in the detection and avoidance of unwanted behavior of users, processes and applications in a communications network or in a device thereof.

2. Description of the Related Art

Enterprises often employ communications networks in order to facilitate communications between and among employees. Related-art enterprise networks are, for example, a collection of hardware devices interconnected by communication channels that allow sharing of resources and information among members of the enterprise. Various types of enterprise networks may include any of a Local Area Network (LAN), a workgroup network, a client-server network, an Intranet, an Extranet, and the like. Mobile devices are commonly incorporated into these enterprise networks.

In related-art networks, security concerns often arise from the unauthorized behavior of a user, a process, or an application running on a network device or combination thereof. Such unauthorized use can result in unwanted loss, damage, and/or divulging of enterprise information. Several types of security measures exist to combat the problem of unauthorized activities occurring within an enterprise network. Often, these security measures use comparative historical data (e.g., the normal or expected behavior of an application) in order to detect any intrusion to the network, or to detect whether any unauthorized behavior is occurring. Alternatively, related-art security measures may use list(s) of static information (e.g., types of signatures, permissions, or the like) that, if present in an application or process, prohibit that application from executing or from continuing to operate.

More particularly, present systems and methods exist for using a statistical analysis of the differences between the normal behavior of, and the current behavior of, a program in order to detect unauthorized activity. Similarly, a behavioral analysis for each of a plurality of processes associated with a processing system can be performed, whereby a protect phase is started for the process when a deviation from normal behavior is detected. Likewise, systems and methods exist which involve receiving a behavior profile associated with an application from a developer, or the like, and determining, if a current operation of the application is not in conformity with the profile, to issue a message to that effect.

Also in existence are systems and methods of protecting a system from attack by monitoring processes, identifying behavior and attributes of the processes, grouping the processes into sets based on commonalities of attributes, and generating behavior control descriptions for each process set.

FIG. 1 is a flowchart illustrating a control flow of an Anomaly Detection System (ADS) according to the related art.

Referring to FIG. 1, the control process begins at step 120, in which the normal behavior profile for a software package or application is generated. This may be performed by the software package manufacturer or by the manufacturer of an anomaly detection system. In step 130, the subject application is installed on a client computer on which the behavior profile (in an ADS) has already been installed. In step 140, the ADS receives the normal behavior profile. In step 150, the ADS begins to monitor the subject application.

Additionally, there exist methods which detect, by using heuristics, unknown malicious code on a host computer system whereby a virus signature is created on local computer and a blacklist is updated with the virus signature of the malicious code. Further detection and remediation of the malicious code can then be achieved without requiring subsequent execution of the malicious code.

FIG. 2 is a flow diagram of a heuristic detection blacklist updating process according to the related art.

Referring to FIG. 2, the control process starts at step 220, in which an operation to search for malicious code on host computer system (not shown) is performed. If malicious code has not been detected, step 220 is repeated. If malicious code has been detected, a mode to remediate the malicious code is entered in step 230, and the detected malicious code is remediated (i.e., terminated, deleted, quarantined, cleaned, and/or otherwise remediated).

Thereafter, at step 240, a check is performed to determine if a blacklist includes the malicious code identifier for the malicious code detected in step 220. If the blacklist includes the correct identifier, control flow returns to step 220. If blacklist does not include a malicious code identifier for the malicious code detected, step 250 is entered whereby a malicious code identifier is created. With the created malicious code identifier, the blacklist is updated at step 260, and a notification is provided at step 270. The process terminated.

Disadvantages of the foregoing related-art techniques include that they are not scalable in view of the multitude of new applications becoming available to consumers of mobile technology. That is, since the above systems and methods are based on an application “profile” or on a static list of items associated with an unwanted attribute of an application or process which needs to be updated regularly, they are impractical. Moreover, such profiles are based on behavior that is derived offline, which requires a controlled environment.

An additional disadvantage of related-art techniques is that present blacklists are merely derived from a list of known malicious applications. This is problematic since a blacklist may also need to include a non-malicious application. For example, a network administrator may desire to blacklist an application that is simply undesirable, or that performs an action that is not malicious. In such a case, the techniques of the related art which operate by using signatures of malicious applications will not work. Additionally, the related art fails to address the situation in which an unwanted or prohibited behavior is performed by more than one single application. That is, an undesirable or unwanted behavior may occur as a result of multiple applications, processes, devices, and/or users working together. Moreover, the related-art techniques may only flag or penalize an application which performs the final step of a particular unwanted or prohibited behavior. At present there is no technique for flagging or penalizing other applications, processes, devices and/or users that use or work in concert with the application that performs the unwanted action.

Therefore, a need exists for a system and method which monitors a communications network for prohibited behavior, identifies users, applications and processes involved in prohibited behavior and applies corrective action to one or more of the users, applications and processes to prevent future prohibited behavior.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a system and method which monitors a communications network for prohibited behavior, identifies users, applications and processes involved in prohibited behavior and applies corrective action to one or more of the users, applications and processes to prevent future prohibited behavior.

In accordance with an aspect of the present invention, a method for detecting behavior in a network device is provided. The method includes generating a list of one or more prohibited behaviors, generating a list of one or more corrective actions, mapping each of the one or more prohibited behaviors to at least one of the one or more corrective actions, identifying one or more of a user, a process or an application involved in a prohibited behavior, and applying, to the one or more of the user, the process or the application involved in the prohibited behavior, the at least one of the one or more corrective actions mapped to the prohibited behavior performed.

In accordance with an aspect of the present invention, a network system comprising a plurality of interconnected devices capable of detecting behavior in a network device is provided. The system includes at least one network device configured to accept a list of one or more prohibited behaviors, to accept a list of one or more corrective actions, to map each of the one or more prohibited actions to at least one of the one or more corrective actions, to identify one or more of a user, a process or an application involved in a prohibited behavior, and to apply, to the one or more of the user, the process or the application involved in the prohibited behavior, the at least one of the one or more corrective actions mapped to the prohibited behavior performed.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart illustrating a control flow of an Anomaly Detection System (ADS) according to the related art;

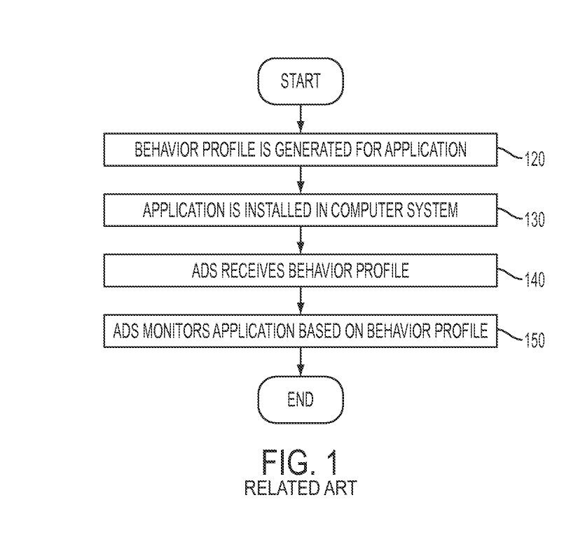

FIG. 2 is a flowchart illustrating a process of updating a heuristic detection blacklist according to the related art;

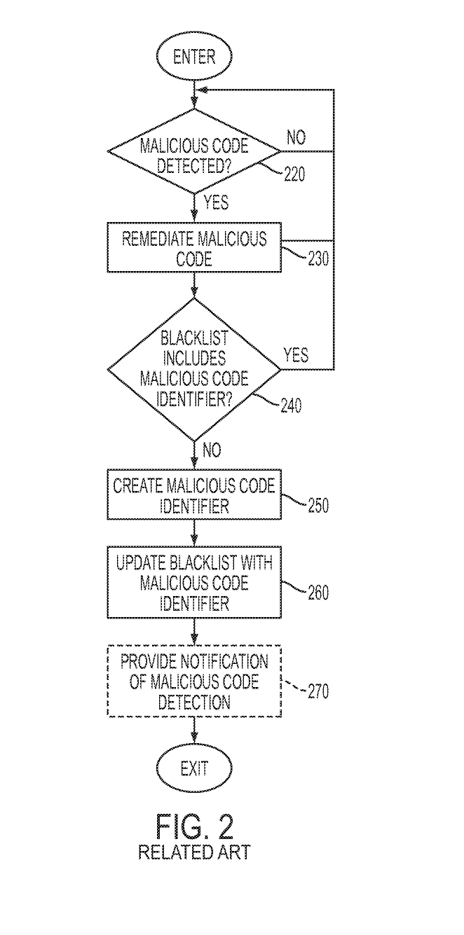

FIG. 3 is a flowchart describing a method for detecting prohibited behaviors in a communications network or device thereof according to an exemplary embodiment of the present invention;

FIGS. 4A-4B are conceptual diagrams illustrating a method for detecting prohibited behaviors and applying corrective actions in a mobile communications network according to an exemplary embodiment of the present invention;

FIGS. 5A, 5B and 5C are diagrams illustrating the inputting of lists of prohibited behaviors, corrective actions and monitoring conditions according to exemplary embodiments of the present invention.

FIG. 6 is a block diagram schematically illustrating a configuration of a communications network according to an exemplary embodiment of the present invention; and

FIG. 7 is a block diagram schematically illustrating a configuration of a mobile device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

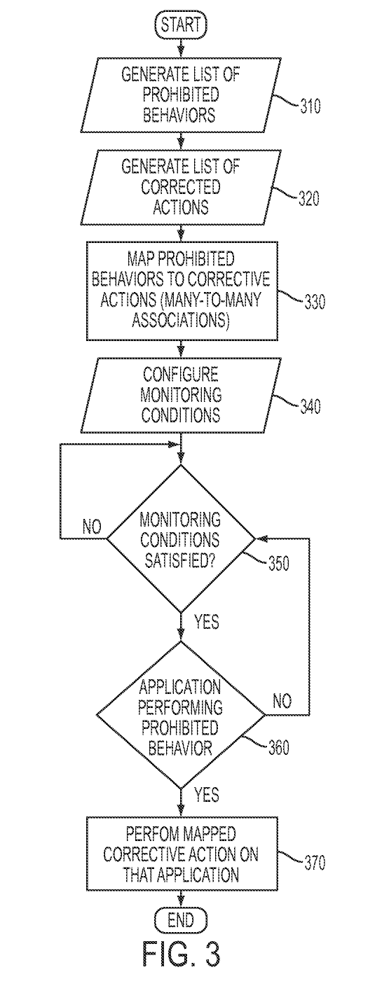

FIGS. 3 through 7, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Exemplary embodiments of the present invention include a system and method for generating a list of prohibited behaviors and a list of corrective actions mapped to the prohibited behaviors that, in connection with monitoring conditions, aid in the detection and avoidance of unwanted behavior of users, processes and applications in a computer or communications network, or in a device thereof. The list of prohibited behaviors may be generated, for example, by a network administrator or a device end user. A prohibited behavior may be one or more actions performed by any user or module of the network system, such as a process or an application. A prohibited behavior may also be one or more actions performed by more than one, or any combination of, a system module, a process, an application or a user. A corrective action may be, for example, one or more actions to be performed when the prohibited behavior occurs. Corrective actions are not limited herein, and may include one or more of, or any combination of, blacklisting the application, blocking the behavior or application, logging the behavior or application, and the like. A monitoring condition can be any criteria devised for monitoring the network to determine if a prohibited behavior or application occurs. Monitoring conditions are not limited herein, and may include monitoring based on time, based on location, based on user, or the like, including any combination thereof. Monitoring conditions may likewise be generated by, for example, a network administrator.

In exemplary embodiments of the present invention, once the monitoring conditions are satisfied, the network begins monitoring for the particular prohibited behavior(s). If a prohibited behavior is detected, the corrective action mapped to the prohibited behavior is performed. In exemplary embodiments, the corrective action may be performed by any one of, or by any combination of, network modules, processes, applications and/or users involved in the prohibited behavior. Exemplary corrective actions may be determined, in whole or in part, based on whether the module, process, application or user is the cause or trigger of the prohibited behavior, or whether such module, process, application or user is an intermediary component of, or is involved in the final performance of, the prohibited behavior. The network may further maintain a list of steps which lead to a prohibited behavior, and may accordingly detect the involvement of other applications. That is, exemplary embodiments of the present invention include dynamic, real-time behavior based monitoring.

FIG. 3 is a flowchart describing a method for detecting prohibited behaviors in a computer network or device thereof according to an exemplary embodiment of the present invention.

Referring to FIG. 3, the process begins at step 310, in which a network administrator, a user of a desktop workstation, a user of a network mobile device, or the like, first generates a list of prohibited behaviors. A prohibited behavior may be, for example, one or more actions performed by any user or any module of the network system, such as a process or an application. Specific prohibited behaviors are not limited herein, and may include gaining or attempting to gain access to unauthorized resources inside or outside of the network. Likewise, a prohibited behavior may be a behavior which interferes with the function of another process or application, or that is undesirable for any other reason. Further examples of prohibited behaviors may include activity that is not malicious per se, but that is otherwise undesirable to a user or network administrator. This may particularly apply, for example, in the case of enterprise networks requiring a high level of security. Specific examples of possible prohibited behaviors may include, for example, making an international call, uploading data to the cloud or to a server, changing device settings, rooting or attempting to root a device, installing or attempting to install a new application, creating false contacts or updating contacts with false information, connecting to an unauthorized or compromised server, sending a premium Short Message Service (SMS) content without a user interaction, and the like.

At step 320, a network administrator, a user of a desktop workstation, a user of a network mobile device, or the like, generates a list of corrective actions. A corrective action may include “blacklisting” an application, blocking the behavior of an application, logging the behavior of an application, or the like, including any combination thereof. The term “blacklisting” herein is not limited, and may alternatively be used to describe any number of corrective actions, such as disabling an application or process, uninstalling an application, informing a user or network server of a prohibited behavior of a network device (e.g., a mobile device), revoking specific permissions or signatures, or blocking specific functions of a user or application, logging actions which were performed or attempted to be performed by a user, process or application (e.g., timestamp, application name, application IDentifier (ID), information about the application in an application manifest, etc.), and the like.

At step 330, a network administrator, a user of a desktop workstation, a user of a network mobile device, or the like, maps the items on the list of prohibited behavior to the items on the list of corrective actions. In exemplary embodiments, a given prohibited action may be mapped to one or more corrective actions and vice-versa. Likewise, a prohibited behavior may be mapped to a same or different corrective action(s) than that mapped to any other prohibited behavior and vice-versa. Many corrective actions may be performed when a single prohibited behavior occurs. Additionally, more than one, or a combination of prohibited behaviors may be mapped to trigger one or more corrective actions.

At step 340, a network administrator, a user of a desktop workstation, a user of a network mobile device, or the like, configures a set of monitoring conditions. A monitoring condition can be any criteria devised for how to monitor the network to determine if a prohibited behavior or application occurs. In exemplary embodiments, monitoring conditions are not limited, and may include monitoring based on time, based on location, based on user, or the like, including any combination thereof. Specific examples of monitoring conditions may be, for example, monitoring all mobile devices and desktop workstations from 8 am to 7 pm daily, or monitoring a subset of mobile devices only when those mobile devices are in London, England.

At step 350, the network determines if a monitoring condition has been satisfied. For example, if a monitoring condition is set to monitor the network during certain hours of the day, then that monitoring condition is satisfied when that designated time of day occurs. If the monitoring condition has not been satisfied, monitoring of step 350 continues. In contrast, if the monitoring condition has been satisfied, the process proceeds to step 360 in order to determine whether a prohibited behavior is occurring.

At step 360, the network monitors all users, devices, modules and combinations thereof in the network in order to determine if a prohibited behavior, or designated combination thereof, is occurring. If it is determined that a prohibited behavior is not occurring, the network returns to step 350 to continue monitoring. In contrast, if a prohibited behavior is detected, the network proceeds to step 370 in order to perform the corrective action(s) mapped to the detected prohibited behavior(s).

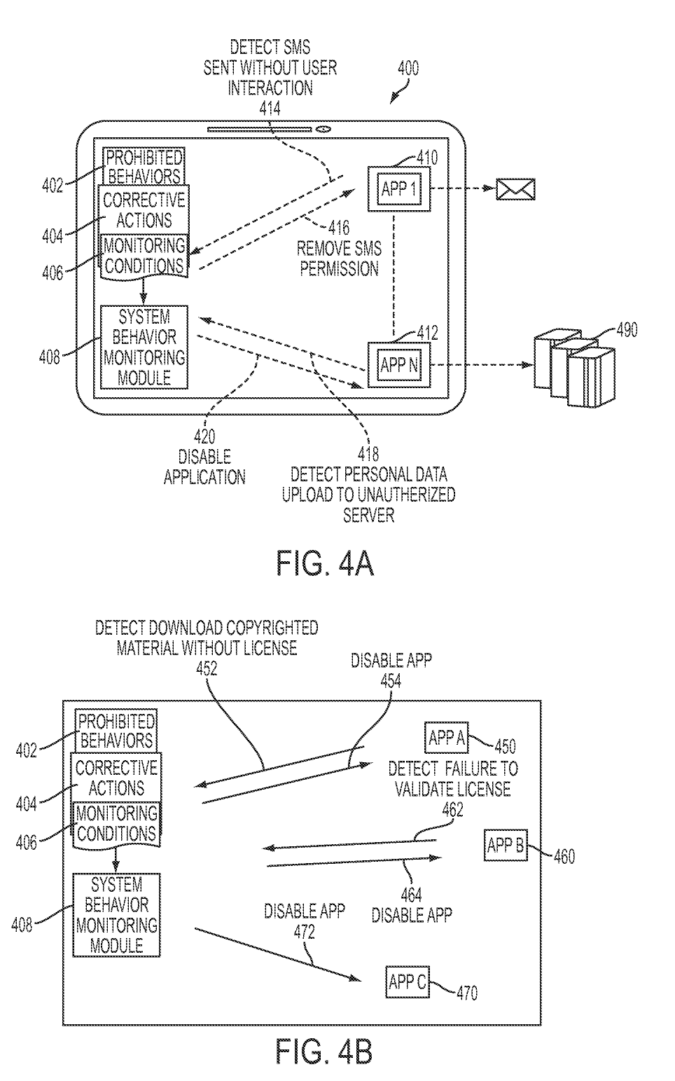

FIGS. 4A-4B are conceptual diagrams illustrating a method for detecting prohibited behaviors and applying corrective actions in a mobile communications network according to an exemplary embodiment of the present invention.

Referring to FIG. 4A, an exemplary method for detecting prohibited behaviors and applying corrective actions in a mobile device is described. A mobile device 400 may be, for example, a mobile device assigned to an enterprise employee that operates in conjunction with an enterprise network (not shown). A respective list of prohibited behaviors 402 and corrective actions 404 have been generated by the user, and the user has further mapped each prohibited behavior 402 to one or more corrective actions 404. Specifically, the user has designated the sending of an unauthorized SMS message 414 as a prohibited behavior, and has devised removal of SMS permission from the responsible application as the corrective action mapped to the sending of the unauthorized SMS message. Likewise, has user has designated the upload of personal data to an unauthorized server 490 as a prohibited action, and has devised disabling of the responsible application as the corrective action mapped to the upload of personal data to an unauthorized server. The list of prohibited behaviors 402 and the corrective actions 404, and the map linking each prohibited behavior 402 to one or more corrective actions 404, are stored locally on the device or on the server (not shown) and are capable of being accessed by a system behavior monitoring module 408. The user has further designated monitoring conditions 406 to be monitored by the system behavior monitoring module 408.

The mobile device 400 may include a first application (App 1) 410 and a second application (App 2) 412. App 1 may be, for example, a text messaging application. In operation, App 1 410 may be determined by the system behavior monitoring module 408, during a monitoring session, to be engaging in a prohibited behavior. For example, App 1 may be sending SMS content without being directed to do so by the user. In this case, the system behavior monitoring module 408 detects the unauthorized SMS message 414 and accesses a list of the corrective actions 404 in order to determine which corrective action is mapped to the prohibited behavior of sending the unauthorized SMS message 414. The system behavior monitoring module 408 determines that the removal of SMS permission 416 is the relevant mapped corrective action and causes removal of SMS permission 416 from the instant messaging application.

In operation, App 2 412 may also be in operation on the mobile device 400. App 2 412 may be, for example, an application that includes a detailed list of business contacts, each contact including personal information or information that may be otherwise desired to be kept confidential. The user may, for example, attempt to upload the personal contact list to an unauthorized server 490 that user licenses for personal use. In this case, the system behavior monitoring module 408 detects a prohibited behavior 418 and accesses the list of the corrective actions 404 in order to determine which corrective action is mapped to the prohibited behavior of uploading personal data to an unauthorized server 420. The system behavior monitoring module 408 determines that the disabling of the responsible application 482 is the relevant mapped corrective action and causes the disabling of App 2 412.

Referring to FIG. 4B, an exemplary method for detecting prohibited behaviors and applying corrective actions in a mobile device is described. The mobile device 400 may include a first application (App A) 450, a second application (App B) 460 and a third application (App C) 470. App A 450 may be, for example, a mobile web browser. App B 460 may be, for example, a copyright license checking application. App C 470 may be, for example, an application that plays media files. The respective list of prohibited behaviors 402 and corrective actions 404 have been generated by the user, and the user has further mapped each prohibited behavior 402 to one or more corrective actions 404. The user has also further the designated monitoring conditions 406 to be monitored by the system behavior monitoring module 408.

In FIG. 4B, the network administrator has designated the downloading of copyrighted materials without a license 452 to be a prohibited action. The administrator has also designated a failure of an application to operate properly at step 462 to be a prohibited action. In this case, App A 450 has downloaded a media file without the license 452, and App B 460 has failed to prevent App A 450 from downloading the media file for which App B 460 has no associated license. Both Applications have thus performed a prohibited behavior, and both prohibited behaviors have been mapped to the corrective action of disabling the respective application responsible for the prohibited behaviors 454 and 464. In this case, both of App A and App B are disabled. Further, in this exemplary embodiment, the administrator has mapped the prohibited action of a failure of App B 460 to the corrective action of disabling certain related programs at step 472, such as programs which have the ability to display, play or disseminate the unauthorized copyrighted works. In this case, since App C 470 is a media player capable of playing the downloaded media file for which there is no license, the corrective action of disabling 472 App C 470 is applied in response to the prohibited action of the failure of App B 460.

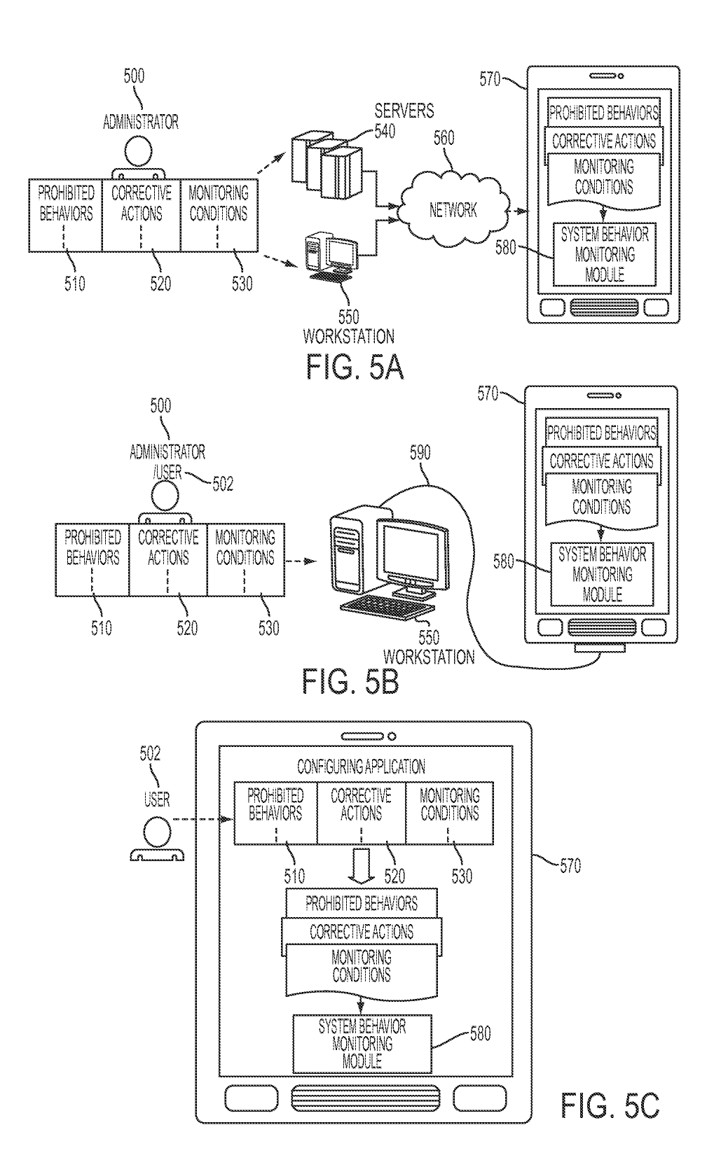

FIGS. 5A, 5B and 5C are diagrams illustrating the inputting of lists of prohibited behaviors, corrective actions and monitoring conditions according to exemplary embodiments of the present invention.

Referring to FIG. 5A, a network administrator 500 generates each of a list of prohibited behaviors 510 and a list of corrective actions 520, and establishes monitoring conditions 530 for a particular mobile device. Network Administrator 500 may then, for example, input the list of prohibited behaviors 510, the list of corrective actions 520, a map linking the prohibited behavior to the corrective actions (not shown), and the established monitoring conditions 530 to enterprise servers 540 or to a network desktop workstation 550. The respective data is then sent through a network 560 to a desired mobile device 570 where it is stored and accessed locally on the desired mobile device 570 by a system behavior monitoring module 580 and related hardware.

Referring to FIG. 5B, a network administrator 500 or a user 502 generates each of a list of prohibited behaviors 510 and a list of corrective actions 520, and establishes the monitoring conditions 530 for a particular mobile device. Network Administrator 500 may then, for example, input the list of prohibited behaviors 510, the list of corrective actions 520, a map linking the prohibited behavior to the corrective actions (not shown), and the monitoring conditions 530 to a network desktop workstation 550. The respective data is then sent, for example, via a Universal Serial Bus (USB) 590, wireless LAN (not shown), or otherwise, to the desired mobile device 570 where it is stored and accessed locally on the desired mobile device 570 by the system behavior monitoring module 580 and related hardware.

Referring to FIG. 5C, a user 502 generates each of a list of prohibited behaviors 510 and a list of corrective actions 520, and establishes monitoring conditions 530 for a particular mobile device. The user 502 may then, for example, input the list of prohibited behaviors 510, the list of corrective actions 520, a map linking the prohibited behavior to the corrective actions (not shown), and the monitoring conditions 530 directly into the desired mobile device 570. The respective data is then stored and accessed locally on the desired mobile device 570 by the system behavior monitoring module 580 and related hardware.

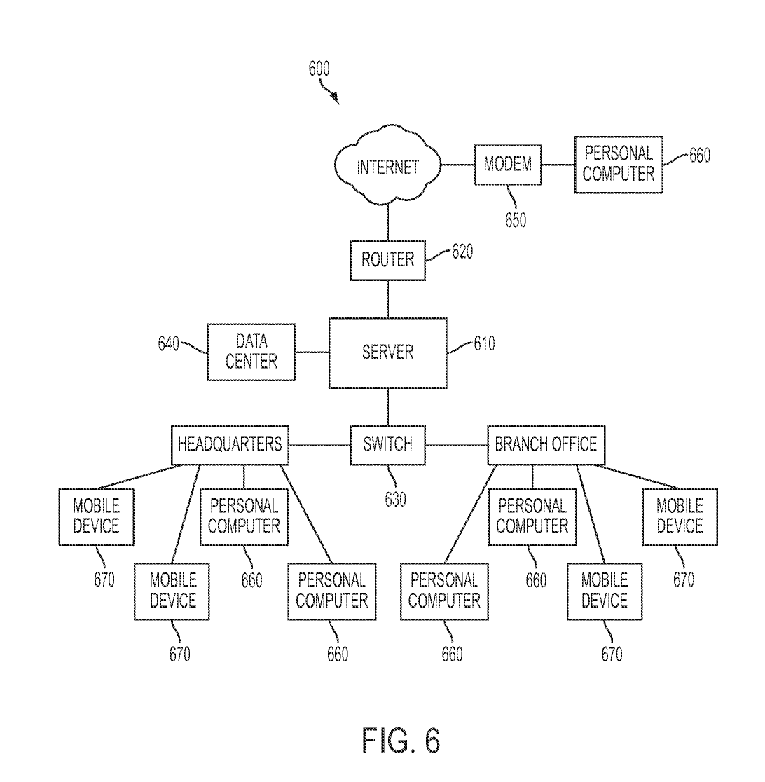

FIG. 6 is a block diagram schematically illustrating a configuration of a communications network according to an exemplary embodiment of the present invention.

Referring to FIG. 6, a communications network 600 is shown according to an exemplary embodiment of the present invention. The network consists of a server 610, a router 620, a switch 630, a data center 640, a modem 650, personal computers 660, and mobile devices 670.

The server 610 may be a conventional Local Area Network (LAN) server, e.g., having one or more processors, Random Access Memory (RAM), and storage means, such as an array of hard disks. The processing capacity and memory of the server are configured to run several applications concurrently. The router 620 may be a conventional router that connects the communications network 600 to the internet. The switch 630 may be a conventional switch and serve as a controller to enable the networked devices to communicate efficiently, share and allocate resources. The data center 640 may be of any suitable configuration that, for example, houses necessary computer systems and associated components, such as telecommunications and storage systems, and may include redundant or backup power supplies, redundant storage devices, redundant data communications connections, network security devices, and the like. The modem 650 may be a conventional modem that, for example, modulates and demodulates an analog carrier signal to encode digital information. The personal computers 660 and the mobile devices 670 may each be, e.g., any type of handheld, tablet, desktop, or other communications or computing device, many of which are widely available and well known in the art.

The network of the present invention is not limited to the exemplary embodiments described herein and may include, for example, any architecture and related computational infrastructure such that a user or network administrator is able to input, at any of various network nodes (e.g., a server, a workstation or a mobile device), each or any of a list of prohibited behaviors, a list of corrective actions, a map linking prohibited behaviors to corrective actions, and/or monitoring conditions as are all described herein. Therefore, for example, if a monitoring condition is set which relies on the position of a controlled device in the network, the network architecture and related computational infrastructure must be able accommodate the monitoring condition. Thus, it must be assumed that certain hardware and software are included in exemplary embodiments of the present invention, e.g., hardware and software such that a desired list of prohibited behaviors can be mapped to a desired list of corrective actions and that the network can monitor for the prohibited action(s) and perform any necessary corrective action. A variety of architectures may be suitable and are known in the art. For example, each of U.S. Patent Application Publication No. 2004/0143740 and No. 2005/0086500, and U.S. Pat. No. 8,225,405 describe related system architecture, elements of which may variously and optionally be included herein.

In exemplary embodiments, the number of network components and devices is not limited. For example, the network may include a plurality of components and devices in addition to those shown in FIG. 6, and that may be within the local environment of the user or that may not be within the local environment of the user. Additional devices and components of the network may be any of a mobile device, a personal computing device, a network server or printer, a media player, a television, a stereo, a digital picture frame and/or any other device that is configured to be within the network and to accept the transfer of applications and data files in the relevant format from the first device.

Types of networks considered suitable in the present invention are not limited to the exemplary embodiments described herein, and may include any of a LAN, a Metropolitan Area Network (MAN), a Wide Area Network (WAN), a Global Area Network (GAN), a Personal Area Network (PAN), workgroup networks, client-server networks, an Intranet, an Extranet and the like. A LAN may be a small computer network usually set up within a single building. A MAN may be a network that covers a metropolitan or a municipality area. A WAN may be a network which covers a large geographical area, such as a country or a continent. A PAN may be a network for a single person. A GAN may be a network with global coverage. Workgroup networks may include a set of desktop computers that can interconnect with each other without a specific weight on a particular computer or piece of hardware. Any of the aforementioned networks may also use a combination of different technologies, such as satellite communications, Bluetooth, Wi-Fi, Wireless Broadband (Wi-Bro), and the like.

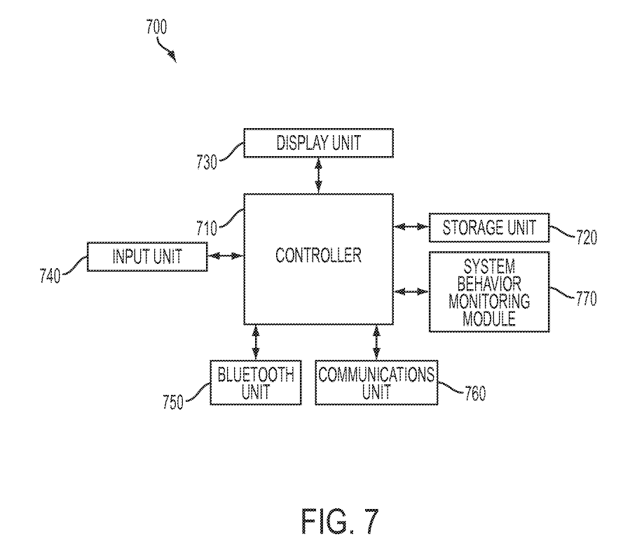

FIG. 7 is a block diagram schematically illustrating a configuration of a mobile device according to an exemplary embodiment of the present invention.

Referring to FIG. 7, a mobile device 700 includes a controller 710, a storage unit 720, a display unit 730, an input unit 740, a Bluetooth unit 750, a communication unit 760 and a system behavior monitoring module 770.

According to exemplary embodiments of the present invention, the mobile device 700 may be configured to transfer data to and/or communicate with at least one device (e.g., a mobile device) over the network of FIG. 6. According to exemplary embodiments of the present invention, the mobile device 700 may be configured to communicate with, and/or select (e.g., enable a user to select) data to transfer to, another device. For example, the mobile device 700 may be configured to identify and copy data to transfer to a clipboard that aggregates data for transfer and associates each of the data (e.g., each of the items) with a device authorized to paste or download the data. According to exemplary embodiments of the present invention, the mobile device 700 may be configured to communicate with at least one server (e.g., a cloud-based server) so as to transfer the data to the target device via the server (e.g., via the cloud). The mobile device 700 may be assigned an identifier from the at least one server upon registration of the mobile device 700 with the server. The identifier associated with the mobile device 700 may be used by other devices to locate the address of the mobile device 700 or to locate on the server data that has been uploaded by the mobile device 700. Likewise, in exemplary embodiments, mobile device 700 may include one or other more applications or processes, which may work independently or in concert, and which may enable or support one or more other applications, processes or users. In exemplary embodiments, such applications may include power or memory management applications, audio, video and image/graphics applications, user input applications, and so forth.

The storage unit 720 can store user data, and the like, as well as a program which performs operating functions according to an exemplary embodiment of the present invention. For example, the storage unit 720 may store a program for controlling general operation of the mobile device 700, an Operating System (OS) which boots the mobile device 700, and an application program for performing other optional functions such as a camera function, a sound replay function, an image or video replay function, a Bluetooth or Near Field Communication (NFC) function, and the like.

Further, the storage unit 720 may store user data generated according to a user of the mobile device, such as, for example, a text message, a game file, a music file, a movie file, and the like. In particular, the storage unit 720 according to exemplary embodiments of the present invention may store a table which stores a mapping of data that may be transferred with devices to which the data may be transferred. For example, the storage unit 720 may store a list of prohibited behaviors, a list of corrective actions that is mapped to the prohibited behaviors and/or a list of monitoring conditions accessible to the controller 710, the system behavior monitoring module 770, and the like.

The Bluetooth unit 750 may be configured for communicating with another device via Bluetooth. According to exemplary embodiments of the present invention, the Bluetooth unit 750 may be configured to automatically pair with another device. For example, the Bluetooth unit 750 may pair the mobile device 700 with another Bluetooth enabled device when the mobile device 700 is brought into close proximity with the other Bluetooth-enabled device. The Bluetooth unit 750 communicates connection data with the other NFC-enabled device during the pairing process. The Bluetooth pairing may be used separate from or in connection with the network of FIG. 6 to communicate connection information between devices known to each other. According to exemplary embodiments of the present invention, the Bluetooth unit 750 may transfer some data such as, for example, metadata to the recipient mobile device before the recipient mobile device confirms the transfer of the data. Data that may be transferred before the recipient mobile device confirms the transfer of data and may include, for example, a file name, a first few words of text, file or data size, the originating device name, and the like.

The communication unit 760 is configured for communicating with other devices and network components. For example, the communication unit 760 may be configured to communicate via the network of FIG. 6. According to exemplary embodiments of the present invention, after the mobile device 700 is registered or recognized in the network, the mobile device 700 may transfer data to another device over the network via the communication unit 760. According to exemplary embodiments of the present invention, the communication unit 760 may transfer some data such as, for example, application data, metadata or other data to a second (target) network component or device before the second (target) network component or device confirms the transfer of the data. Data that may be transferred before the second (target) network component or device confirms the transfer of data may include, for example, a file name, a first few words of text, file or data size, the originating device name, and the like.

The input unit 740 may include input keys and function keys for receiving user input. For example, the input unit 740 may include input keys and function keys for receiving an input of numbers or various sets of letter information, setting various functions, and controlling functions of the mobile device 700. For example, the input unit 740 may include a calling key for requesting a voice call, a video call request key for requesting a video call, a termination key for requesting termination of a voice call or a video call, a volume key for adjusting output volume of an audio signal, a direction key, and the like. In particular, the input unit 740 according to exemplary embodiments of the present invention may transmit to the controller 710 signals related to selection of data to transfer and/or selection of devices to which the data may be transferred. Such an input unit 740 may be formed by one or a combination of input means such as a touch pad, a touch screen, a button-type key pad, a joystick, a wheel key, and the like.

The display unit 730 displays information inputted by the user or information to be provided to the user as well as various menus of the mobile device 700. For example, the display unit 730 may provide various screens according to the user of the mobile device 700, such as an idle screen, a message writing screen, a calling screen, and the like. In particular, the display unit 730 according to exemplary embodiments of the present invention can display a menu. The menu may include a list of functions relating to the transfer of data across devices. For example, the menu may include a list including a function corresponding to copying data to a device, pasting data from a device, cutting data and pasting such data to a device, and the like. The menu may be displayed to enable a user to select data to be transferred and/or to select a device to which the data may be transferred. For example, the display unit 730 may display an interface which the user may manipulate or otherwise enter inputs via a touch screen to enter selection of the data that may be transferred or selection of devices to which the data may be transferred. The display unit 730 can be formed as a Liquid Crystal Display (LCD), an Organic Light Emitting Diode (OLED), an Active Matrix Organic Light Emitting Diode (AMOLED), and the like. However, the present invention is not limited to these examples. Further, the display unit 730 can perform the function of the input unit 740 if the display unit 730 is formed as a touch screen.

According to exemplary embodiments of the present invention, the mobile device comprises at least one controller. The controller 710 may be configured to operatively control the mobile device 700. For example, the controller 710 may control operation of the various components or units included in the mobile device 700. The controller 710 may transmit a signal to the various components included in the mobile device 700 and control a signal flow between internal blocks of the mobile device 700. In particular, the controller 710 according to exemplary embodiments of the present invention can control selection of data to that may be transferred, selection of at least one device to which the data may be transferred, receipt of an indication of transfer from the device to which the data may be transferred, receipt of confirmation of transfer of the data to the other device, association of data that may be transferred with a device to which the data may be transferred, copy of data to a clipboard for aggregating data that may be transferred, deletion of the data associated with a cutting function after the mobile device 700 has confirmed that the pasting of the data to another mobile device is complete or abandoned (e.g., either explicitly by a user of the mobile device 700 or the other mobile device, or via a timeout), and registration of data to be copied to a clipboard with an identifier associated with a corresponding device to which the data may be transferred. According to exemplary embodiments of the present invention, the controller 710 may be configured to control the transfer of some data such as, for example, metadata, to the recipient mobile device before the recipient mobile device confirms the transfer of the data. Data that may be transferred before the recipient mobile device confirms the transfer of data may include, for example, a file name, a first few words of text, file or data size, the originating device name, and the like. A user of the recipient mobile device may view and select which data to proceed with transferring based at least in part on the data transferred before confirmation of the transfer of data. For example, the data transferred before confirmation of the transfer of data may be used to enable a user to make a more informed decision as to which data to paste to the recipient device.

According to exemplary embodiments of the present invention, the mobile device may optionally comprise a system behavior monitoring module 770. The system behavior monitoring module 770 may be configured to operate in conjunction with the at least one of the controller 710 and the storage unit 720 in accordance with configurations and methods known in the art, as are otherwise described herein, and which are incorporated herein by reference

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of detecting behavior in a network device, the method comprising:
generating a list of one or more prohibited behaviors;
generating a list of one or more corrective actions;
mapping each of the one or more prohibited behaviors to at least one of the one or more corrective actions;
identifying one or more of a user, a process or an application involved in a prohibited behavior; and
applying, to the one or more of the user, the process or the application involved in the prohibited behavior, the at least one of the one or more corrective actions mapped to the prohibited behavior performed.

2. The method of claim 1, further comprising:
configuring a set of one or more monitoring conditions; and
monitoring a network device to determine if the one or more monitoring conditions has been satisfied.

3. The method of claim 2, wherein the monitoring is based on a user, a time period, a geographic location or a combination thereof.

4. The method of claim 1, wherein the one or more prohibited behaviors are actions performed by two or more selected from among users, applications, processes, or any combination thereof, operating in part or in whole on two or more network devices.

5. The method of claim 1, wherein the method is applied to detect behavior on a per-device basis.

6. The method of claim 1, wherein the generating of the list of the one or more prohibited behaviors, the generating of the list of the one or more corrective actions and the mapping of each of the one or more prohibited behaviors to the at least one of the one or more corrective actions are capable of being generated by any one of a network administrator, a user of a desktop workstation or a user of a mobile device in a network.

7. The method of claim 1, wherein at least one of the one or more prohibited behaviors involves gaining or attempting to gain unauthorized access to resources or services.

8. The method of claim 1, wherein the one or more corrective actions may be any action selected from among uninstallation of an application, revocation of rights or privileges, logging the prohibited behavior, and issuing a notice or sending a message of the prohibited behavior.

9. The method of claim 1, further comprising, when the prohibited behavior is performed, mapping a process by which the prohibited behavior is performed; and
identifying, using the map of the process by which the prohibited behavior is performed, related users, processes or applications.

10. The method of claim 1, wherein the one or more corrective actions are based on the level of involvement of the user, the process or the application involved in the prohibited behavior.

11. A network system comprising a plurality of interconnected devices capable of detecting behavior in a network device, the system comprising:
at least one network device configured to accept a list of one or more prohibited behaviors, to accept a list of one or more corrective actions, to map each of the one or more prohibited actions to at least one of the one or more corrective actions, to identify one or more of a user, a process or an application involved in a prohibited behavior, and to apply, to the one or more of the user, the process or the application involved in the prohibited behavior, the at least one of the one or more corrective actions mapped to the prohibited behavior performed.

12. The system of claim 11, wherein the at least one network device is further configured to accept a list of one or more monitoring conditions and to monitor one or more network devices to determine if the one or more monitoring conditions have been satisfied.

13. The system of claim 12, wherein the monitoring is based on a user, a time period, a geographic location, or a combination thereof.

14. The system of claim 11, wherein the one or more prohibited behaviors are actions performed by two or more selected from among users, applications, processes, or any combination thereof, operating in part or in whole on two or more network devices.

15. The system of claim 11, wherein the system is applied to detect behavior on a per-device basis.

16. The system of claim 11, wherein the at least one network device is further configured accept input of the list of the one or more prohibited behaviors, the list of the one or more corrective actions and the map of each of the one or more prohibited behaviors to the at least one of the one or more corrective actions at any of a server, a desktop workstation or at a network mobile device.

17. The system of claim 11, wherein at least one of the one or more prohibited behaviors involves gaining or attempting to gain unauthorized access to resources or services.

18. The system of claim 11, wherein the one or more corrective actions may be any action selected from among uninstallation of an application, revocation of rights or privileges, logging of the prohibited behavior, and issuance of a notice or message regarding the prohibited behavior.

19. The system of claim 11, wherein the at least one network device is further configured to, when the prohibited behavior is performed, perform a process of mapping the behavior by which the prohibited behavior is performed; and
identify, using the map of the process by which the prohibited behavior is performed, related users, processes or applications.

20. The system of claim 19, wherein the one or more corrective actions are based on the level of involvement of the user, the process or the application involved in the prohibited behavior.
